(19) United States
(12) Patent Application Publication
(10) Pub. No.: US 2011/0056055 A1
(43) Pub. Date: Mar. 10, 2011

(54) MEMBER FOR LOCKING RING SECTORS ON A TURBINE ENGINE CASING, INCLUDING RADIAL PASSAGES FOR GRIPPING SAME

(75) Inventors: Alain Dominique Gendraud, Vernou La Celle Sur Seine (FR); Erwan Daniel Botrel, Alfortville (FR)

(73) Assignee: SNECMA, Paris (FR)

(21) Appl. No.: 12/991,641

(22) PCT Filed: May 14, 2009
(86) PCT No.: PCT/EP2009/055814

§ 371 Date: Nov. 16, 2010

(30) Foreign Application Priority Data
May 16, 2008 (FR) 0853183

(51) Int. Cl. F16B 2/24

(52) U.S. Cl. 24/457

(57) ABSTRACT

A locking member for a device used to fasten ring sectors on a casing of an aircraft turbine engine, wherein the member includes two clamping arms connected together at the rear end thereof by a connection arm extending substantially parallel to the general spacing direction between the two clamping arms. The member includes, on either side of a virtual median plane orthogonal to the circumferential direction, a passage for gripping the member, each passage being formed through the connection arm, emerging in an inter-arm space.

### TECHNICAL FIELD

The present invention generally concerns a locking member for fastening ring sectors on an aircraft turbine engine casing, for example a turbine casing.

The invention also concerns a turbine engine for an aircraft comprising such locking members, this turbine engine being able to assume the form of a turbo-prop or a turbojet engine.

### BACKGROUND OF THE INVENTION

Known from the prior art are rings circumferentially fastened on the casing around mobile vanes of the turbine of a turbojet engine, these sectors jointly forming a continuous cylindrical enclosure outwardly defining the gas passage stream in the turbine. The ring sectors are mounted on an inner casing of the turbine using casing elements, called intermediate casing elements or spacers, on which they are hooked by their front ends and maintained at their back ends by C-shaped or sideways U-shaped locking members. The latter parts are axially/longitudinally engaged from the rear on circumferential rims of the back ends of the ring sectors and the intermediate elements of the casing, to keep them radially pressed against each other.

This fastening of the ring sectors on the intermediate elements of the turbine casing allows them to follow the heat expansions and contractions of the turbine casing, in which hot gas or cold gas is injected to control its heat expansions and contractions in order to keep as little radial play as possible between the inner surfaces of the ring sectors and the ends of the mobile vanes of the turbine, and thereby increase the turbine's efficiency.

In a known manner, the locking members jointly form an annular locking device centered on the axis of the turbine engine, each member therefore only forming one angular sector of that device. Each member comprises two longitudinal clamping arms extending axially/longitudinally toward the back and connected at their back ends by a connection arm, while their front ends are intended to press at least one ring sector between them against at least one casing element. The latter two elements radially pressed against each other are effectively provided to be housed in the space formed between the two longitudinal arms, longitudinally open towards the front.

The locking members are designed, in particular concerning the elasticity and separation of the two longitudinal arms, so that the applied radial gripping is high performance. Yet in such a case, the removal of these locking members, required for example during maintenance operations of the turbine, is extremely difficult, due to the significant radial gripping force exerted by the longitudinal arms on the circumferential rims. Because of this, the removal usually requires the operator to use a tool, which generally has a shape that is not adapted, likely to damage the locking members, as well as the surrounding elements. Such a situation arises for example during the use of a screwdriver, which the operator tries to slide between one of the longitudinal arms of the member and the circumferential rim in contact with that arm. In fact, the screwdriver is then used as a lever arm, likely to damage both the concerned longitudinal arm and circumferential rim, or to injure the operator.

As a result, the design of current locking members does not allow quick and easy removal, and also creates significant risks of damaging the clamping arms during such a removal.

### BRIEF DESCRIPTION OF THE INVENTION

The invention therefore aims to at least partially resolve the abovementioned drawbacks, relative to the embodiments of the prior art.

To do this, the invention first concerns a locking member for a device used to fasten ring sectors on the casing of an aircraft turbine engine, said member extending along a circumferential direction between a first circumferential end and a second circumferential end, said member having, in cross-section along the plane orthogonal to said circumferential direction, two clamping arms connected together at the rear end thereof by a connection arm extending substantially parallel to the general spacing direction between the two clamping arms, the front ends of the two clamping arms being intended to press at least one ring sector against at least one casing element between them.

According to the invention, said member is provided, on either side of a fictional median plane orthogonal to said circumferential direction, with a passage for gripping said member, each passage being formed as a through-passage in said connection arm, emerging in an inter-arm space defined between the clamping arms.

Thus, the member according to the invention originally provides for means for its gripping, intended to facilitate its removal after it has been placed on the ring sectors, for example using a suitable tool.

Moreover, the particular positioning of the passages through the connection arm, i.e. away from the front ends of the clamping arms ensuring the pressing of the ring sectors, implies that they can easily cooperate with a removal tool without risking damaging the functionalities of that locking member, in particular therefore due to the absence of direct contact between the tool and the aforementioned front ends. In other words, gripping these passages with a tool does not create any direct mechanical stress on the clamping arms, which therefore do not risk being damaged by the pressure from the tool, the stresses in fact being concentrated on the connection arm offset towards the back of the sensitive area. This advantage is also found in the preferred case where the tool is intended to pass through the passages to penetrate the inter-arm spaces, so that the ends of that tool abut against the inner surface of the connection arm, near these same passages.

Thus, it is contemplated for the tool to cooperate with the walls of the passages, and/or with the inner surface of the connection arm.

Preferably, each passage extends along a guideline substantially orthogonal to the circumferential direction and the spacing direction. Preferably, this line is a straight line, for example extending substantially axially, therefore with the aforementioned spacing direction corresponding to the radial direction.

In other words, each straight line is preferably parallel to an axis of the turbine equipped with a plurality of these members to ensure the pressing of the ring sectors against the casing elements. Of course, the orientation of the guidelines of the passages could be different from the axial/longitudinal direction, without going beyond the scope of the invention.

Preferably, the two passages are arranged on or near said first circumferential end and said second circumferential end, respectively. These ends correspond to the portions of the member that are the least stressed when the member is in the gripping condition of the ring sectors, such that the presence of the passages at these locations only creates a negligible mechanical weakening of the member, not requiring any overdimensioning of the surrounding areas.

Preferably, each passage is substantially cylindrical, with an axis corresponding to said guideline.

According to one preferred embodiment, each passage assumes the form of a slot extending along the guideline, i.e. the bottom of said slot extends substantially parallel to the radial direction. Preferably, it is provided that each slot is formed so as to open in said circumferential direction.

Preferably, each slot has, seen from the outside in relation to the member and along said guideline, a substantially semi-circular or substantially semi-oblong shape.

Whatever the contemplated case, each slot allows the connection arm to be passed through by a tool, the ends of which can then cooperate with the inner surface of said arm, near the slots. The aforementioned inner surface therefore constitutes a stop surface for the tool, substantially oriented towards the inter-arm space it defines. This stop surface can indeed serve as a bearing surface for a removal tool, which can then be stressed in the longitudinal direction towards the back in order to cause the desired removal.

According to another preferred embodiment of the present invention, each passage has, seen from the outside in relation to the member and along said guideline, a closed delimiting line. In this respect, this may involve a delimiting line with a general oblong or circle shape, of the bore type.

Preferably, the locking member forms an angular sector of an annular locking device, intended to be centered on the axis of the turbine equipped with such a device.

The invention also concerns a device for fastening ring sectors on an aircraft turbine engine, comprising casing elements formed with first circumferential rims on which second back circumferential rims of the ring sectors are applied, the fastening device also comprising a plurality of locking members as described above, engaged on said first and second circumferential rims to keep them pressed against each other. In such a case, the first and second circumferential rims, extending towards the back in the longitudinal direction, therefore penetrate through the front opening of the members defined between the clamping arms, in order to be kept radially pressed against each other there.

The invention also concerns an aircraft turbine engine turbine comprising a device for fastening ring sectors as described above, and/or at least one locking member as described above. It may alternatively involve a turbine engine compressor, without going beyond the scope of the invention.

Lastly, the invention concerns an aircraft turbine engine comprising a turbine as described above, and/or a device for fastening ring sectors as described above, and/or at least one locking member as described above, this turbine engine being able to be a turbojet engine or a turbo-prop, indifferently.

Other advantages and features of the invention will appear in the non-limiting detailed description below.

### BRIEF DESCRIPTION OF THE DRAWINGS

This description will be done in light of the appended drawings, which:

FIG. 1 is a partial longitudinal cross-sectional view of a device for fastening ring sectors on a turbine casing of an aircraft turbine engine, according to one preferred embodiment of the present invention, this view also corresponding to a cross-sectional view along plane P1 of FIG. 3, orthogonal to the circumferential direction and passing through one of the passages for gripping the member;

FIG. 2 is an enlarged partial view similar to that shown in FIG. 1, this view also corresponding to a cross-sectional view along plane P2 of FIG. 3, constituting a fictional median plane orthogonal to the circumferential direction;

FIG. 3 shows a perspective view of a locking member belonging to the device for fastening ring sectors shown in FIGS. 1 and 2;

FIG. 4 shows, enlarged, the locking member shown in FIG. 1;

FIG. 5 shows the member shown in FIGS. 3 and 4, in cross-section passing through the two clamping arms, and orthogonally to the guidelines of the two passages;

FIGS. 6a to 6c diagram a method for removing the locking member shown in FIGS. 1 to 5, with FIG. 6b corresponding to a view along line VIb-VIb of FIG. 6a;

FIG. 7 shows a view similar to that shown in FIG. 3, the locking member respectively assuming the form of an alternative embodiment.

### DETAILED DESCRIPTION OF PREFERRED EMBODIMENTS

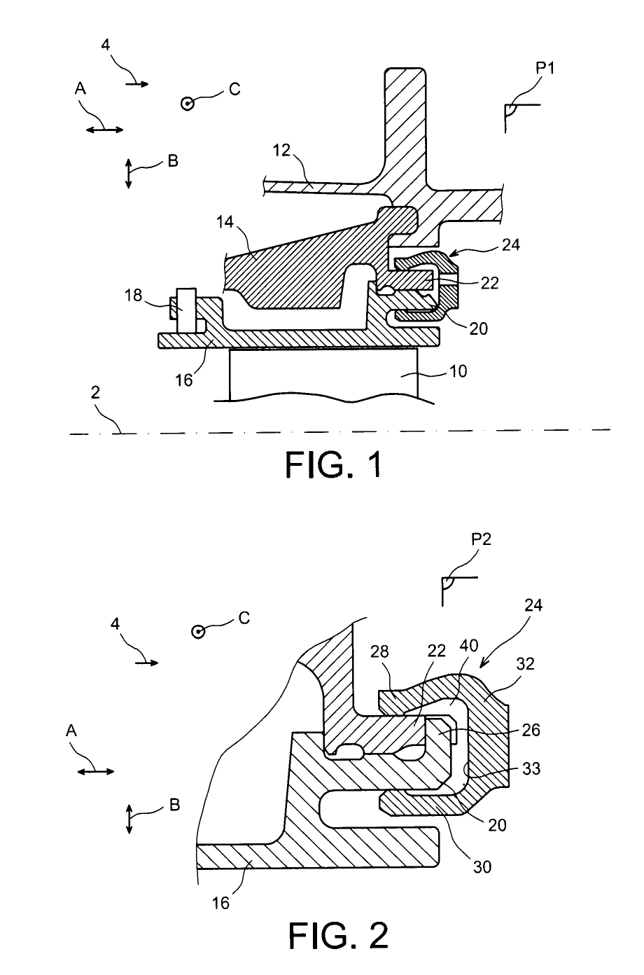

In reference jointly to FIGS. 1 and 2, it is possible to see a device for fastening ring sectors on a turbine casing of an aircraft turbine engine, according to one preferred embodiment of the present invention.

In the figures, direction A corresponds to the longitudinal or axial direction, parallel to the longitudinal axis 2 of the turbine of the turbine engine. Direction B corresponds to the radial direction of the turbine, and direction C to the circumferential direction. Moreover, arrow 4 diagrams the main direction of the flow of gas within the turbine engine, parallel to direction A, the terms “front,” “upstream,” “back,” “downstream” used in the continuation of the description being used in reference to a direction of forward movement of the aircraft under the effect of the thrust from the turbine engine, this direction of forward movement being opposite the direction of arrow 4.

In FIG. 1, reference 10 designates the mobile vanes of a high-pressure turbine stage of a turbine engine, which rotates in a turbine casing 12 inside which the casing elements 14 are fastened, called spacers or intermediate casing elements. The elements 14 support ring sectors 16 arranged circumferentially around the axis of rotation 2 of the turbine, along direction C, the inner surfaces of these ring sectors forming a continuous cylindrical surface that outwardly defines a gas passage stream in the turbine.

The ring sectors 16 have an angular scope around the axis of the turbine, in direction C, of about 10 to 20° , and there are for example around thirty of them.

Each ring sector 16 comprises, at its upstream end or front end, a circumferential rim 18 in cylinder portion form, by which it is hooked or fastened on a spacer 14, and also comprises at its back end or downstream end a circumferential rim 20 in cylinder portion form that is applied against a corresponding circumferential rim 22 in cylinder portion form of the spacer 14. Hereinafter, the circumferential rim 22 is called first circumferential rim, and the circumferential rim 20 is called second circumferential rim.

The two circumferential rims 20 and 22 extending in direction A are kept pressed against each other in direction B in which they are superimposed, by a C- or sideways U-shaped locking member 24 that is engaged from the back on the circumferential rims 20 and 22 and that keeps them radially pressed against each other.

Jointly, the locking members 24 form an annular locking device centered on the axis 2, which is an integral part of the fastening device of the ring sectors. Thus, each member 24 assumes the form of an angular sector of the annular locking device, extending for example over about 10 to 20° , in direction C. To form a complete, preferably continuous ring, they are provided adjacent in direction C, for example around thirty of them centered on the axis 2.

In this respect, it is noted that although the angular area of the members 24 around the axis 2 of the turbine can be of the same order as that of the ring sectors 16, this area can alternatively be higher, without going beyond the scope of the invention. Thus, depending on the case, it is possible to provide one locking member 24 per ring sector 16, or one locking member 24 for several ring sectors 16.

The ring sectors 16, the spacers 14 and the locking members 24 are metal, made of a metal matrix composite (CMC), or of other materials, and the locking members 24 are elastically mounted clamped on the circumferential rims 20 and 22, to press them against each other with a certain pre-stress in the radial direction B, as will be detailed below.

As diagrammatically shown in FIG. 2, the second circumferential rim 20 of the ring sector 16 ends at its back end with radial teeth 26 oriented outwardly, and engaged in corresponding notches of the first circumferential rim 22 of the spacer 14, so as to immobilize each ring sector 16 in rotation around the axis 2 of the turbine on a spacer 14.

Generally, each locking member 24 comprises, in cross-section along a plane orthogonal to direction C as is the case in FIG. 2, two clamping arms 28 and 30, called radially outer and radially inner longitudinal arms, respectively, that are rigidly connected to each other at their back end by a connection arm 32, and the front ends of which are applied on the outer cylindrical face of the first circumferential rim 22 of the spacer 14 and on the inner cylindrical face of the second circumferential rim 20 of the ring sector 16, respectively. Globally, the circumferential arms 28, 30 extend longitudinally in direction A, and are spaced away from each other in a general spacing direction, here preferably corresponding to radial direction B. The circumferential arm 32 extends substantially in this spacing direction, i.e. in radial direction B, to connect the two back ends of the arms 28, 30. These last two arms therefore jointly form an inter-arm space open towards the front in direction A for the passage of the rims 20, 22, and closed towards the back in this same direction A by the connection arm 32, and more specifically by an inner surface 33 thereof.

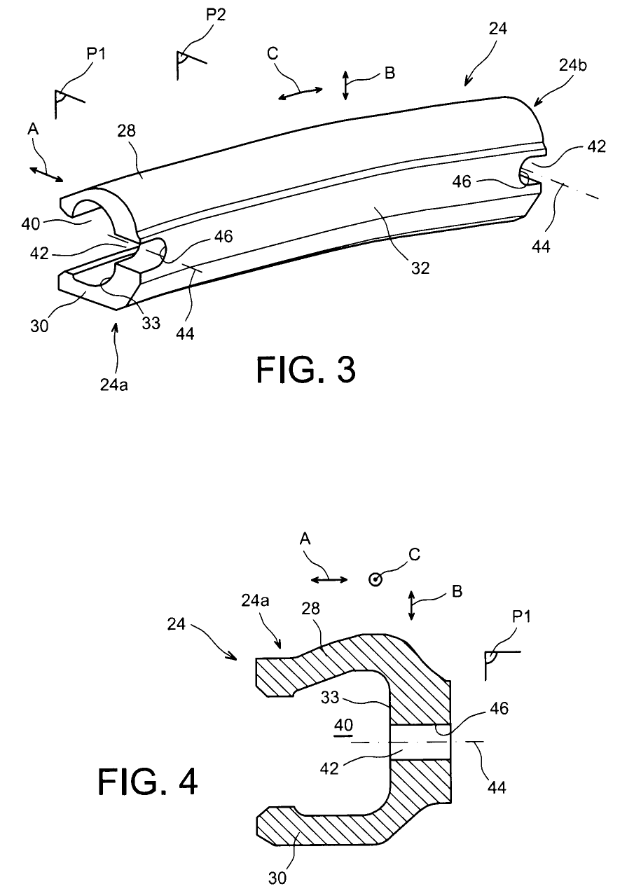

While FIG. 2 shows that the member 24 assumes, in cross-section orthogonal to direction C, a C or sideways U shape, it must be understood that the member extends under this form over a given angular sector along direction C, between a first circumferential end 24a and a second circumferential end 24b, as shown in FIG. 3.

More specifically in reference to this figure, one of the particularities of the present invention lies in the installation, preferably at the circumferential ends 24a, 24b or near them, of means allowing the gripping of the locking member 24, globally arranged towards the back thereof, i.e. on the connection arm 32.

This means assumes the form of two passages, each in slot form, respectively provided on either side of the plane P2 constituting a fictional median plane orthogonal to direction C. More specifically and as mentioned above, the two slots 42 are respectively arranged at the ends 24a, 24b, and have the particularity of each extending along a straight guideline 44, preferably positioned axially, parallel to the arms 28, 30 and orthogonally to the connection arm 32. For information, the two straight lines 44 are therefore substantially parallel, and spaced circumferentially apart from each other.

In reference jointly to FIGS. 3 to 5, it is possible to see that each slot 42 extends cylindrically along its straight guideline 44, while being formed through the arm 32, to emerge in the inter-arm space 40, at the inner surface 33.

In the illustrated preferred embodiment, each slot 42 is formed only through the arm 32, away from the two arms 28, 30. Nevertheless, each arm could extend more significantly in radial direction B, for example to the two clamping arms 28, 30, without going beyond the scope of the invention.

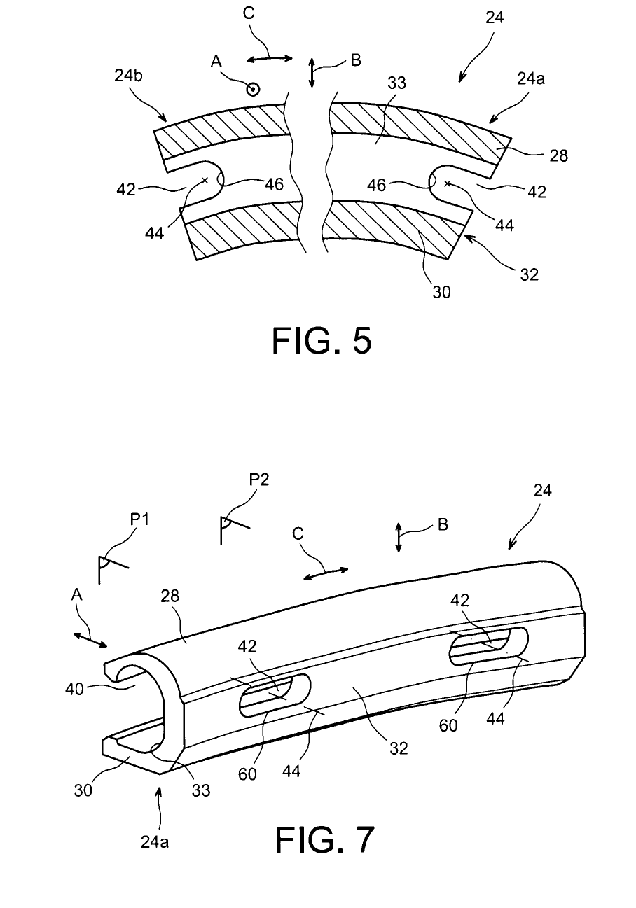

Each slot 42 opens in the circumferential direction C, i.e. its bottom 46 is oriented in that same direction, towards the outside of the member. Preferably, seen outwardly in relation to the member and along the guideline 44, like that of FIG. 5, the slot 42 assumes a substantially semi-oblong shape, with the corresponding circle half-diameter at the bottom 46 of the slot.

This bottom 46 forms a gripping surface for a removal tool. Nevertheless, the gripping of the member with the tool is preferably done using the inner surface 33 of the arm 32, forming a stop surface for the ends of a tool having passed through that same arm 32, through the slots 42 provided to that end. This stop surface 33 can indeed serve as a bearing surface for a removal tool 24, which can then be stressed in the longitudinal direction towards the back in order to cause the desired removal. The particular positioning of these slots, offset towards the back on the member 32, implies that the removal tool can easily cooperate with the member without risking damaging the functionalities thereof, in particular therefore due to the absence of direct contact between the front end of the arms 28, 30.

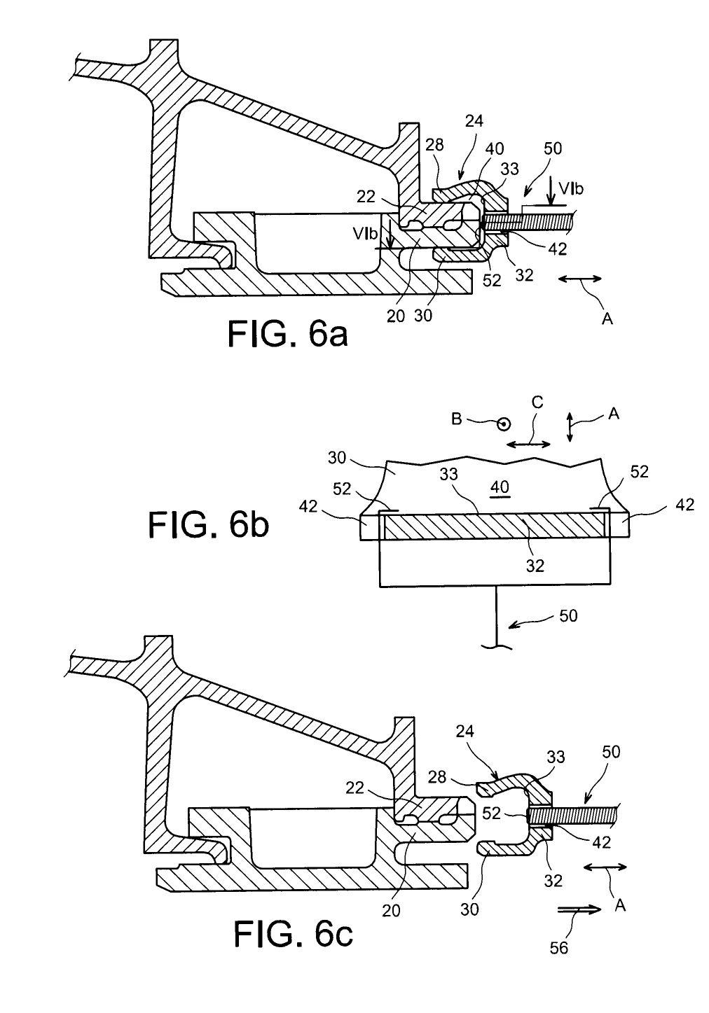

In reference now to FIGS. 6a and 6c, a method is diagrammed targeting the removal of a locking member 24 initially situated in its gripping position of the ring sectors 16, shown in the preceding figures. To do this, a tool 50 of a suitable shape is used, this tool globally having a stirrup-shaped head having two arms respectively provided with two ends 52 opposite each other, capable of being moved in direction C. The two opposite ends 52 are respectively inserted in the two slots 42 until they penetrate the inter-arm space 40, for example by moving the tool in relation to the member 24 in direction A. Then, as shown diagrammatically in FIG. 6b, the two ends 52 are brought closer to each other along direction C, so as to be brought opposite the inner surface 33 of the arm 32, near the two slots 42, respectively. At that moment, the two arms of the stirrup head pass through the two slots 42, respectively. The tool 50 is then stressed in the longitudinal direction A towards the back, manually or automatically, which results in putting the ends 52 in contact with the inner stop surface 33, as shown in FIG. 6a. Continuing this action on the tool 50, diagrammed by arrow 56 in FIG. 6c, results in gradually moving the member 24 in direction A by sliding towards the back of the arms 28, 30 on the rims 20, 22, until complete removal of the member 24 releasing the ring sectors.

Other designs can be provided for the locking member according to the invention, like that shown in FIG. 7, in which the passages 42 are substantially recentered, i.e. spaced away from the circumferential ends 24a, 24b, while remaining positioned on either side of the fictional median plane P2.

The embodiment that is shown here also differs from the preceding one in that the two passages no longer assume the form of slots, but are like bores. Indeed, each passage 42 has, seen (not shown) outwardly in relation to the member and along guideline 44, a closed delimiting line 60, for example circular or oblong. The passages 42 formed in the arm 32 are naturally through-passages, in particular to allow, as in the first preferred embodiment, the introduction of the ends of a removal tool into the inter-arm spaces, for their cooperation with the inner stop surface of the clamping arm 32.

Of course, various changes can be made by a person skilled in the art to the invention just described, solely as non-limiting examples.

1-16. (canceled)

17. A locking member for a device used to fasten ring sectors on a casing of an aircraft turbine engine, the member extending along a circumferential direction between a first circumferential end and a second circumferential end, the member comprising:
in cross-section along a plane orthogonal to the circumferential direction, two clamping arms connected together at a rear end thereof by a connection arm extending substantially parallel to a general spacing direction between the two clamping arms,
the front ends of the two clamping arms configured to press at least one ring sector against at least one casing element between them,
wherein the member includes, on either side of a fictional median plane orthogonal to the circumferential direction, a passage for gripping the member, each passage being formed as a through-passage in the connection arm, emerging in an inter-arm space defined between the clamping arms.

18. The locking member according to claim 17, wherein each passage extends along a guideline substantially orthogonal to the circumferential direction and the spacing direction.

19. The locking member according to claim 18, wherein each guideline is a straight line.

20. The locking member according to claim 17, wherein the two passages are arranged on or near the first circumferential end and the second circumferential end, respectively.

21. The locking member according to claim 19, wherein each passage is substantially cylindrical, with an axis corresponding to the guideline.

22. The locking member according to claim 19, wherein each guideline extends substantially axially.

23. The locking member according to claim 19, wherein each passage as in a form of a slot extending along a guideline.

24. The locking member according to claim 23, wherein each slot is formed so as to open in the circumferential direction.

25. The locking member according to claim 24, wherein each slot has, seen from the outside in relation to the member and along the guideline, a substantially semi-circular or substantially semi-oblong shape.

26. The locking member according to claim 19, wherein each passage has, seen outwardly in relation to the member and along the guideline, a closed delimiting line.

27. The locking member according to claim 26, wherein each delimiting line assumes a general oblong or circle shape.

28. The locking member according to claim 17, forming an angular sector of an annular locking device.

29. A device for fastening ring sectors on an aircraft turbine engine, comprising:
casing elements including first back circumferential rims on which second back circumferential rims of the ring sectors are applied; and
a fastening device comprising a plurality of locking members according to claim 17, engaged on the first and second circumferential rims to keep them pressed against each other.

30. An aircraft turbine engine turbine comprising:
a device for fastening annular sectors according to claim 29.

31. An aircraft turbine engine turbine comprising at least one locking member according to claim 17.

32. The turbine engine according to claim 31, which is a turbojet engine or a turbo-prop.
